(19) United States
(12) Patent Application Publication
(10) Pub. No.: US 2008/0201247 A1
(43) Pub. Date: Aug. 21, 2008

(54) Method, system and computer-readable media for evaluation or selection of real estate appraisers

(76) Inventor: Jeffery Joseph Bradford, San Jose, CA (US)

Correspondence Address: PATRICK REILLY, P.O. BOX 7218, SANTA CRUZ, CA, 95061-7218, US

(21) Appl. No.: 11/716,906

(22) Filed: Mar. 12, 2007

Related U.S. Application Data
(63) Continuation-in-part of application No. 60/901,737, filed on Feb. 17, 2007.

(51) Int. Cl. G06Q 40/00

(52) U.S. Cl. 705/35

(57) ABSTRACT

A system and method for using information technology to enable selecting candidates for a real property appraisal assignment from among a population of real estate appraisers. A database contains information about the appraisal history of each of the population of appraisers. A query engine accepts specifications concerning a subject property from a user. The use may direct the query engine to identify appraisers that have experience in appraising real properties located within a certain distance from the subject property. The user may specify that only appraisals performed within a certain time period may be counted as valid appraisal experience. The user may direct the query engine to count references of comparable properties that lie within the specified distance from the subject property in appraisals performed by an appraiser as valid experience in selecting and ranking appraisers for an appraisal assignment.

### FIELD OF THE INVENTION

The present invention relates generally to valuation or appraisals of real property. The present invention more particularly relates to techniques and systems for selecting, tasking or assigning persons, teams, or entities regarding one or more aspects of real estate valuation processes.

### BACKGROUND OF THE INVENTION

Prior Art real estate valuation methods often include an appraisal of the market value of a subject real property by a licensed or otherwise legally certified appraiser. The competence of the selected real estate appraiser is usually a key factor in the accuracy, reliability of a real property appraisal.

The appraiser must typically be certified or licensed within his or her state and/or locality. Appraisers are normally authorized according to the requirements of applicable state and federal laws, rules and regulations. Appraisers are generally qualified to do business as an appraiser under rules and regulations not only of the state or locality but also under the auspices of various certifying entities on a national or regional basis.

The mortgage lending industry makes loans to individuals based on several criteria including a valuation of the “subject property.” One of the principal steps in the decision of whether to make a loan and its appropriate amount (the “underwriting” of the loan) is the valuation of the subject property that will secure a promissory note and mortgage. In general, the value of the subject property that secures the lender's interest must equal or exceed the purchase price to which the buyer/borrower and seller agree in the contract of sale. As such, the real estate valuation is often a critical step in the mortgage lending process.

Appraisals today are typically of one of two types. The first is a “full” appraisal of the property. The second is a “drive-by” appraisal. The “full” appraisal process, in general, is as follows. Within a few days of the loan application, a mortgage lender orders an appraisal of the property securing the mortgage. The lender orders this appraisal either directly from an appraiser, a corporate-owned internal management company, an external vendor management company, or through an “appraisal management company,” which then orders the appraisal from a residential real estate appraiser. If the appraiser accepts the assignment, the appraiser might make an appointment to inspect the interior and exterior of the property with its owners or their real estate agents. An appraiser's inspection of the subject property often occurs between two and four days after the appraisal order is placed. The appraiser conducts a physical inspection of the interior and exterior of the property, notes any unusual or notable characteristics and measures each room (or at least the foundation dimensions) to arrive at the approximate square footage. The appraiser might take photographs of the exterior and, often, the interior of the subject property. The entire inspection and picture-taking process can take from a few hours up to a full day.

In practice, the appraiser should review several comparable properties in order to select those that form an appropriate basis for comparison. The appraiser typically uses the sales prices of comparable properties that have recently sold to establish a value for the subject property. The appraiser may also consider the period of time that has elapsed between the sale of the comparable properties and the current date in adjusting the comparables' sales prices to that of the subject property.

A “drive-by” appraisal, generally, is performed in a similar fashion to the “full” appraisal except that the appraiser does not conduct an interior inspection of the subject property. The drive-by appraisal is utilized in a variety of situations, such as where the credit or other risks attendant to the borrower of the type of loan are less, and thus the need for accuracy in the valuation process is deemed less. These situations and methodology are likewise dictated by and under guidelines set both by the secondary market and by individual lenders. In general, a drive-by appraisal takes significantly less time to complete (as the appraiser does not need to schedule an interior inspection of the subject property) and costs considerably less.

Over the past few years, methods have been introduced to value residential property in a fashion that is quicker and less expensive. All of these methods utilize publicly and privately available databases of the sales prices that have been obtained for prior sales of real estate. These methods, while somewhat different, each use a computer-generated model to match a subject property to several apparently comparable properties using only a “data match” comparison model (commonly known as the “automated assisted valuation model” or “AVM”). The purpose of such database methods is to replace the use of the local appraiser with a database match method for generating a computer-produced value.

The Prior Art analyzes data provided by real estate appraisers but fails to optimally enable a user to select one or more appraisers on the basis of the appraisers history of real property valuations. What is needed is an improved method and system by which a lender, or other party desiring a valuation, can better select an appraiser in view of a selected subject property or selected properties.

The Prior Art includes efforts to improve real estate valuation systems and methods. U.S. Pat. No. 7,146,337 discloses a system and a method for originating loans; U.S. Pat. No. 7,130,810 discloses a method and a system for property valuation in an on-line computing environment; U.S. Pat. No. 7,089,202 discloses a method and a system for internet banking and financial services; U.S. Pat. No. 6,988,082 discloses computerized systems and methods for facilitating the flow of capital through the housing finance industry; U.S. Pat. No. 6,901,384 discloses a system and a method for automated process of deal structuring; U.S. Pat. No. 6,898,574 discloses a lender and insurer transaction processing system and method; U.S. Pat. No. 6,842,738 discloses a system and a method for providing property value estimates; U.S. Pat. No. 6,671,677 discloses a system and a method for reducing mortgage interest rate and mortgage guaranty insurance premiums associated with a mortgage loan; U.S. Pat. No. 6,345,258 discloses an information system for new home builders; U.S. Pat. No. 6,233,566 discloses a system, a method and a computer program product for online financial products trading; U.S. Pat. No. 6,049,781 discloses a relocation tracking system and method; and U.S. Pat. No. 5,857,174 discloses a real estate appraisal method and device for standardizing real property marketing analysis by using pre-adjusted appraised comparable sales.

In additional Prior Art work, US Patent Application Serial No. 20060161482 discloses a method and a system for aggregating real estate information content in an on-line computing environment; US Patent Application Serial No. 20060122918 discloses a method and an apparatus for testing automated valuation models; US Patent Application Serial No. 20060085234 discloses a method and an apparatus for constructing a forecast standard deviation for automated valuation modeling; US Patent Application Serial No. 20060015364 discloses a system and methods for acquiring an interest in real property; US Patent Application Serial No. 20050240429 discloses a method for assembling, organizing, disseminating and managing information relating to real estate transactions; US Patent Application Serial No. 20050154657 discloses a method of condition scoring for a property appraisal system; US Patent Application Serial No. 20050154656 discloses a method of ranking comparable properties for appraisal; US Patent Application Serial No. 20050044050 discloses techniques for valuing, insuring, and certifying a valuation of landscape architectures; US Patent Application Serial No. 20040254803 discloses a method and a system for optimized real estate appraisal; US Patent Application Serial No. 20040073508 discloses a method and a system for property valuation in an on-line computing environment; US Patent Application Serial No. 20040049440 discloses a real estate appraisal auxiliary system, a storage medium with a computer software program stored therein for use by a computer system to assist in appraising real estate, and a real estate appraisal auxiliary method; US Patent Application Serial No. 20030212565 discloses an appraisal and home inspection process; and US Patent Application Serial No. 20030036963 discloses a method and a system for aggregating real estate information content in an on-line computing environment

The entire disclosures of each and every patent and patent application mentioned in this present disclosure, to include U.S. Pat. No.'s 7,146,337; 7,130,810; 7,089,202; 6,988,082; 6,901,384; 6,898,574; 6,842,738; 6,671,677; 6,345,258; 6,233,566; 6,049,781; and 5,857,174, as well as US Patent Application Serial No.'s 20060161482; 20060122918; 20060085234; 20060015364; 20050240429; 20050154657; 20050154656; 20050044050; 20040254803; 20040073508; 20040049440; 20030212565; and 20030036963 as noted above, are incorporated herein by reference and for all purposes.

The Prior Art analyzes real estate appraisal data but fails to optimally enable a user to select one or more appraisers for assignment to evaluate a subject property. It is an object of the method of the present invention to provide an improved method and system by which a party desiring a real estate valuation may be enabled to select one or more candidates to task with a real property appraisal assignment in view of a selected subject property or properties and the candidates appraisal history.

### SUMMARY OF THE INVENTION

Towards this object and other objects that will be made obvious in light of this disclosure, a first version of the method of the present invention provides a system for enabling a user to select an appraiser for an assignment of appraising a subject real property.

In certain alternate preferred embodiments of the method of the present invention, a user queries a data base manager or a query engine to identify appraisers that have previously appraised properties located within a specified distance from the subject real property and within a specified time period, e.g., no later than six months prior to the user query. Alternatively or additionally, the user may task the data base manager or query engine with to identify appraisers that have previously referenced comparable properties appraised properties located within a specified distance from the subject real property and within appraisals of real property performed within a specified time period, e.g., comparable property references made within appraisals performed no later than six months prior to the user query.

The appraiser identification process may be fee based or subscription based and may be applied within or by means of an information technology system having a software database.

Various alternate preferred embodiments of the method of the present invention may optionally comprise (a.) storing a plurality of histories of real property appraisals by each of a plurality of appraisers in the software database; (b.) comparing a subject or target real property against the plurality of histories; and (c.) determining the history that lists the most real property appraisals proximate to the target real property (d.) communicating an appraiser selection to a user or customer, wherein the user or the customer provides a fee or subscription compensation for the selection of the appraiser and a communicated identification of one or more selected appraisers; and (e.) ranking at least two appraisers for experience in appraising real properties proximate to the target property.

It is understood that the term target property as used herein is synonymous with the term subject property.

Certain yet alternate preferred embodiments of the method of the present invention provide computer-readable media comprise software-encoded instructions that direct the information technology system to practice one or more aspects of the method of the present invention.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 is a schematic drawing of an electronics communications network that includes a computational system providing a software database function;

FIG. 2 is a detailed schematic of the computational system of FIG. 1;

FIG. 3 is an entity diagram of database software maintained on or accessible to the computational system and/or the electronics communications network of FIG. 1;

FIG. 4 is a schematic of an appraiser profile record as stored in a database of the network of FIG. 1; P FIG. 5 is a schematic of an appraisal history record as stored in a database of the network of FIG. 1;

FIG. 6 is a schematic of a comparable property history record as stored in a database of the network of FIG. 1;

FIG. 7 is a schematic of an appraisal record as stored in a database of the network of FIG. 1;

FIG. 8 is a schematic of a comparable property data record as stored in a database of the network of FIG. 1;

FIG. 9 is an example of a query input submitted to, or generated by, a database manager and/or a query engine of the network of FIG. 1;

FIG. 10 is a flowchart of the system software of the computer or a workstation of the network of FIG. 1, wherein a first preferred embodiment of the method of the present invention is implemented;

FIG. 11 is a process chart of a business method comprising a first alternate preferred embodiment of the method of the present invention that may be implemented by means of the electronic communications network of FIG. 1;

FIG. 12 is a schematic diagram of a user record stored within the database software of FIG. 3;

FIG. 13 is a schematic diagram of an appraiser account record stored within the database software of FIG. 3;

FIG. 14 is a flow chart of a user or appraiser interaction with the database software of FIG. 3 and in accordance with a second preferred embodiment of the method of the present invention;

FIG. 15 is a flow chart of a user or an appraiser interaction with the database software of FIG. 3 and in accordance with a third preferred embodiment of the method of the present invention;

FIG. 16 is a flow chart of an appraiser interaction with the database software of FIG. 3 and in accordance with a fourth preferred embodiment of the method of the present invention; and

FIG. 17 is a flow chart of an alternate or additional appraiser interaction with the database software of FIG. 3 and in accordance with a fifth preferred embodiment of the method of the present invention.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

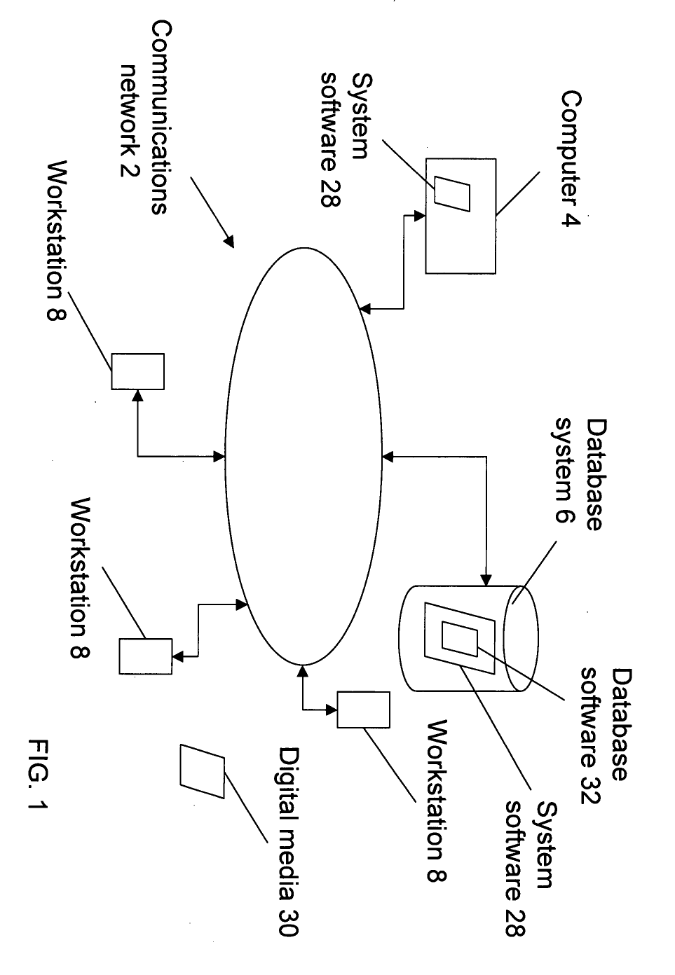

Referring now generally to the Figures and particularly to FIG. 1, FIG. 1 is a schematic drawing of an electronics communications network 2 that includes a computational system 4 providing a software database function. The electronics communications network 2 (hereafter “network”) includes a plurality of database systems 6 and computer workstations 8. The network 2 may be, comprise or partially comprise the Internet. The computational system 4 (hereafter “computer”), database systems 6, and the computer workstations 8 may comprise, or be comprised within, (1.) a personal computer, workstation or server configured for running WINDOWS XP™ operating system marketed by Microsoft Corporation of Redmond, Wash., (2.) a computer workstation or server configured to run, and running, a LINUX or UNIX operating system, and/or (3.) other suitable computational system known in the art configured for software database management and accessibility. In particular, the computer 4 may be a personal computer, such as (a.) an VAIO FS8900 ™ notebook computer marketed by Sony Corporation of America, of New York City, N.Y., (b.) an Apple Mac Book Pro ™ personal computer, or (c.) other suitable computational system known in the art, and configured for wireless and/or landline connectivity with the Internet and/or the world wide web.

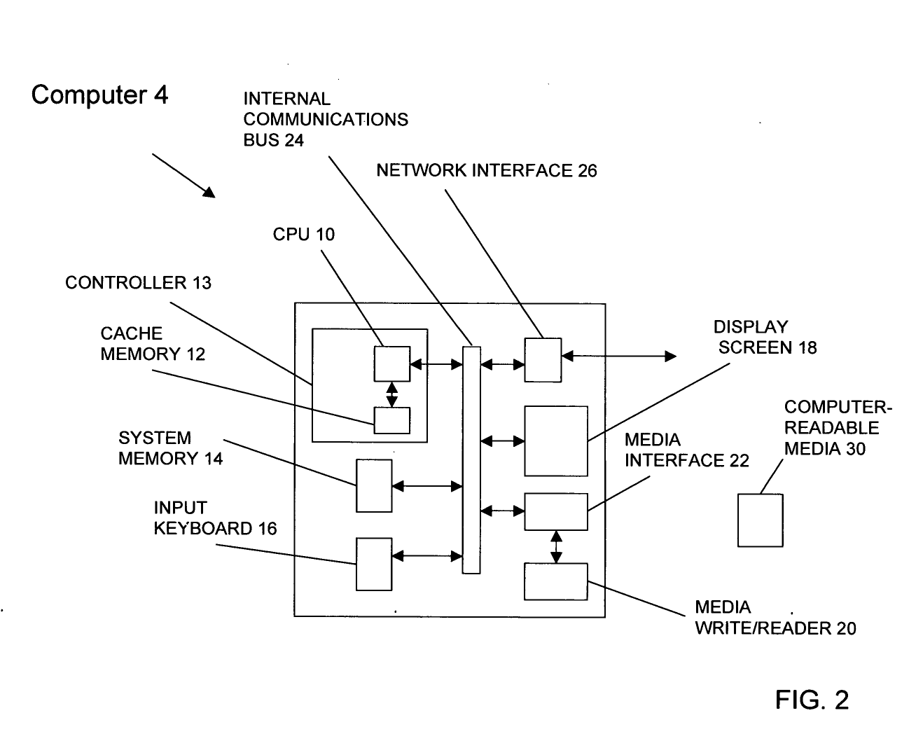

Referring now generally to the Figures and particularly to FIG. 2, FIG. 2 is a detailed schematic of the computer of FIG. 1. The computer 4 includes a central processing unit 10 (hereafter “CPU”), a cache memory 12 of the CPU 10, a controller 13 comprising the CPU 10 and cache memory 12, a system memory 14, a data input device 16, a display device 18, a media reader 20, a media reader interface device 22, an internal communications bus 24, and a network communications interface device 26. The CPU 10, the system memory 14, the data input device 16, the display device 18, the media reader interface 20, and the network interface device 26 are communicatively coupled by means of the internal communications bus 24. The network communications interface device 26 communicatively couples the computer 4 with the network 2 via the CPU 10 and the internal communications bus 24. The media reader interface device 22 communicatively couples the media reader 20 with the CPU 10 and the system memory 14 by means of the internal communications bus 24. The system memory 14 stores a part or all of a system software 28 of the computer 4.

The media reader 20 is configured to read computer-readable and machine executable instructions stored in a computer-readable medium 30 and transmit the read instructions to the CPU 10 and the system memory 14. The terms “computer-readable medium” and “computer-readable media” as used herein refer to any suitable medium known in the art that participates in providing instructions to the network and/or the computer. Such a medium may take many forms, including but not limited to, non-volatile media, volatile media, and transmission media. Non-volatile media includes, for example, optical or magnetic disks, such as may be comprised within the system memory. Volatile media includes dynamic memory. Transmission media includes coaxial cables, copper wire and fiber optics.

Common forms of computer-readable media 30 include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer system can read.

Various forms of computer-readable media 30 may be involved in carrying one or more sequences of one or more instructions to the network for execution. For example, the instructions may initially be carried on a magnetic disk of a remote workstation 8, e.g. a remote server 8. The remote server 8 can load the instructions into its dynamic memory and send the instructions over a telephone line using a modem. A modem local to or communicatively linked with the network 2 can receive the data on the telephone line and use an infra-red transmitter to convert the data to an infra-red signal. An infrared detector can receive the data carried in the infrared signal and appropriate circuitry can provide the data to the network 2.

It is understood that one or more workstations 8 or database systems 6 may comprise one or more elements similar in function in combination or singularity to one or more of the elements 10-28 & 32 of the computer 4.

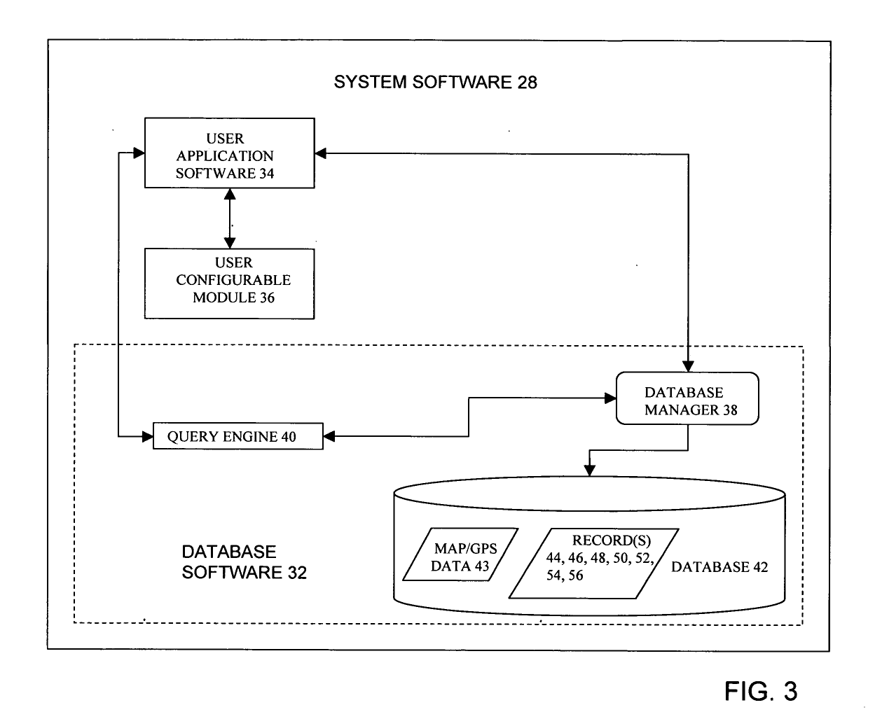

Referring now generally to the Figures and particularly to FIG. 3, FIG. 3 is an entity diagram of a database software 32 and the system software 28 maintained on, and/or accessible to, the computer 4, one or more database systems 6, one or more workstations 8 or servers 8, and/or the network 2 of FIG. 1. The network 2 may host computer system software 28 on a single computational system 4, 8, or 10, or distributively among two or more computational systems 4, 6, & 8. The system software 28 includes a (a.) user application software 34 (b.) one or more user configurable or user-defined components 36; (c.) a database manager 38; and (d.) a query engine 40. The database software 32 comprises the query engine 40, the database manager 38, and a software database 42. The software database 42 comprises a map/GPS data collection 43 and plurality of records 44-56. The database manager 38 accepts queries, instructions, commands and data from a computational system 4, 6 or 8, or via the network 2, and thereupon accesses and modifies the software database 42 in compliance with the received queries, instructions, commands and data.

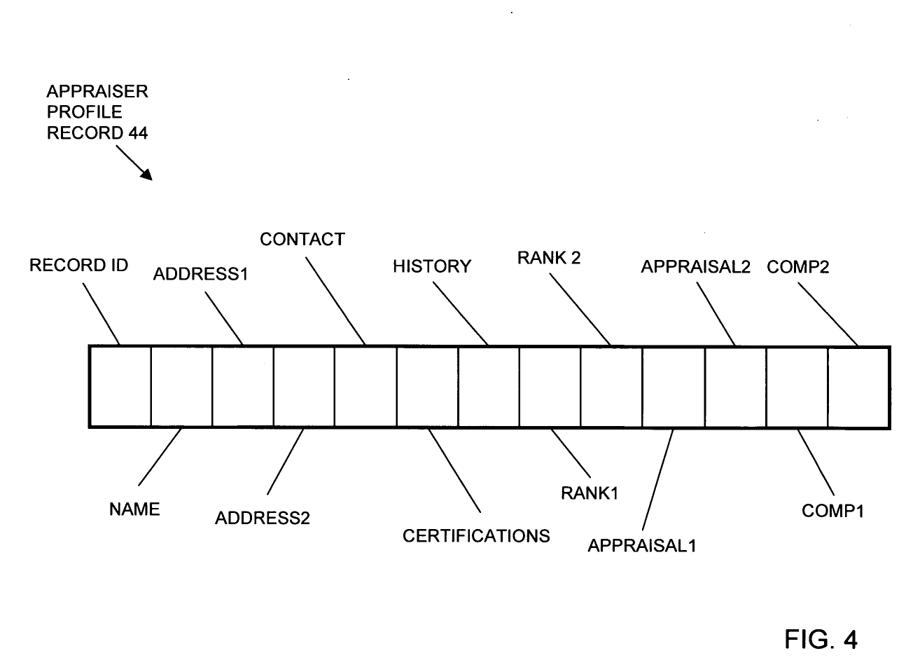

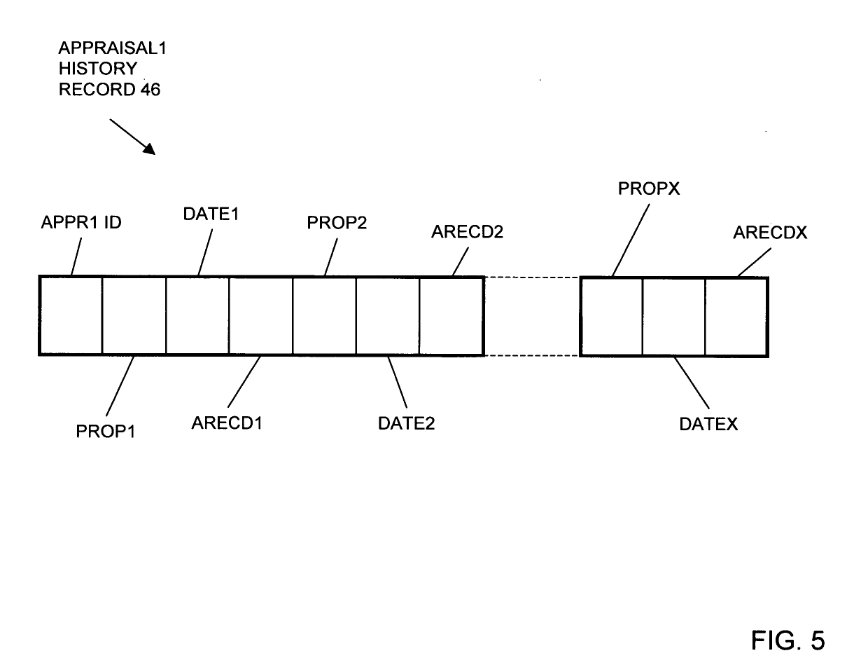

Referring now generally to the Figures and particularly to FIG. 4, FIG. 4 is a schematic of an appraiser profile record 44 as stored in a software database 42 of the network 2 of FIG. 1. The appraiser profile record 44 (hereafter “profile”) comprises a plurality values, to include: record identifier RECORD ID, a name of an appraiser NAME, a first mailing address of the appraiser ADDRESS1, a second mailing address of the appraiser ADDRESS2, contact data (e.g., an email address, a website universal resource locator, a fax number, and/or a telephone number) CONTACT, legal and professional certification indicators CERTIFICATIONS, historical data concerning the appraiser HISTORY, a first ranking of the appraiser according to a first appraiser ranking protocol RANK1, a second ranking of the appraiser according to a second appraiser ranking protocol RANK2, a first appraisal history identifier APPRAISAL1, A SECOND appraisal history identifier APPRAISAL2, a first comparable property history identifier COMP1, and a second comparable property history identifier COMP2. In exemplary embodiment of the first appraiser ranking protocol RANK1, a RANK1 value may a quality ranking of accuracy and/or reliability of the appraiser referenced identified by the NAME field of a same appraiser profile record 44.

Referring now generally to the Figures and particularly to FIG. 5, FIG. 5 is a schematic of a first appraisal history record 46 (hereafter “appraisal history”) as stored in a software database 42 of the network 2 of FIG. 1. The first appraisal history 46 comprises a plurality values, to include: the history identifier APPRAISAL1, a first appraised property identifier PROP1, a date DATE1 of an appraisal made of the property identified in by PROP1, and a record identifier ARECD1 of an appraisal record made of the property identified by PROP1 on the date specified by DATE1 and performed by the appraiser identified in the NAME data field of the appraiser record of FIG. 4. The appraisal history further includes the history identifier APPRAISAL2, a second appraised property identifier PROP2, a date DATE2 of an appraisal made of the property identified in by PROP2, and a record identifier ARECD2 of an appraisal record made of the property identified by PROP2 on the date specified by DATE1 and performed by the appraiser identified in the NAME data field of the appraiser record of FIG. 4. The appraisal history may include up to an X number of appraisal property identifiers is PROPX, dates DATEX of appraisals of the referenced properties, and a plurality of record identifiers ARECDX that are each separately used by the database manager of FIGS. 1 and 3 and to locate and reference an appraisal record made of the property identified each PROPX on the date specified by the respective DATEX value and performed by the appraiser identified in the NAME data field of the appraiser profile record 44 of FIG. 4

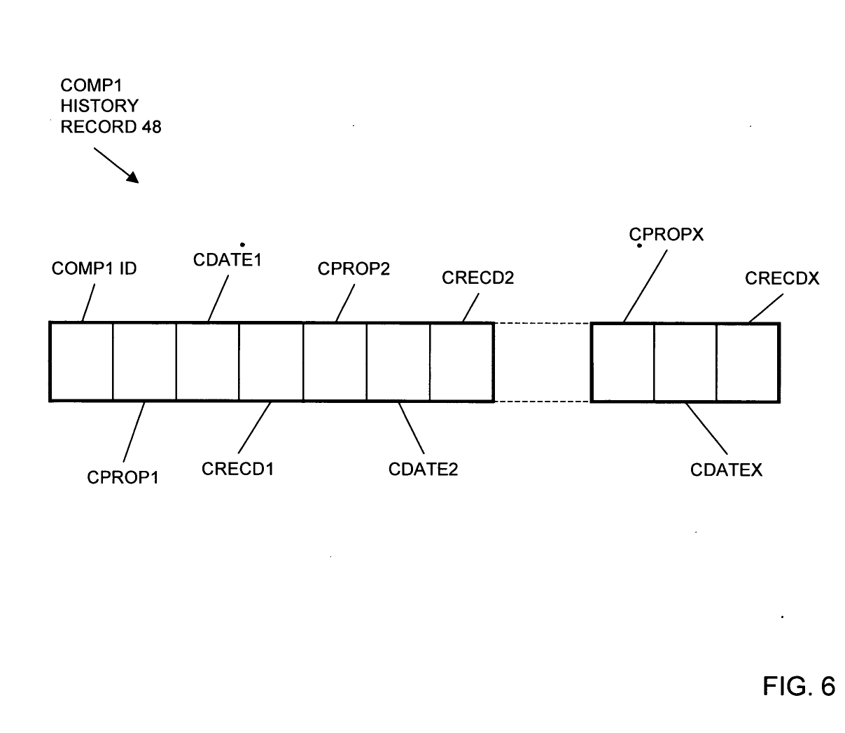

Referring now generally to the Figures and particularly to FIG. 6, FIG. 6 is a schematic of a comparable property history record 48 (hereafter “comp history”) as stored in a software database 42 of the network 2 of FIG. 1. The comp history 48 comprises a plurality values, to include: the comp history identifier COMP1, a first comparable property identifier CPROP1, a date CDATE1 of a comparable property reference made of the first comparable property identified in by CPROP1, and a record identifier CRECD1 of a comparable record reference made of the first comparable property identified by CPROP1 on the date specified by CDATE1 and referenced by the appraiser identified in the NAME data field of the appraiser record of FIG. 4. The comp history further includes the comp history identifier COMP2, a second comparable property identifier CPROP2, a date CDATE2 of a comparable property reference made of the second comparable property identified in by CPROP2, and a second record identifier CRECD2 of the comparable record reference made of the second comparable property identified by CPROP2 on the date specified by CDATE2 and referenced by the appraiser identified in the NAME data field of the appraiser record of FIG. 4. The comp history may include up to an X number of comparable property identifiers CPROPX, dates DATEX of appraisals of the referenced comparable properties, and a plurality of comparable property reference record identifiers CRECDX that are each separately used by the database manager of FIGS. 1 and 3 and to locate and reference a comparable property reference record made of the comparable property identified each CPROPX on the date specified by the respective CDATEX value and performed by the appraiser identified in the NAME data field of the appraiser profile record 44 of FIG. 4.

It is understood that the information retained and disclosed by various alternate preferred embodiments of the method of the present information will be stored, accessed, processed, shared, maintained and disclosed only in accordance with, as permitted by, and as required by all applicable laws, and in accordance with all applicable governmental or legally enforceable regulations and court orders. It is further understood that all information accessed and processed in accordance with certain preferred embodiments of the method of the present invention processed will consist only of information legally permitted to be processed in the execution of each relevant preferred embodiment of the method of the present invention. In one exemplary application of legal requirements, real estate valuation and sales information will not be stored, accessed, processed, shared, maintained or disclosed in any way that is noncompliant with all applicable laws, legally enforceable regulations and court orders. The compliance of these embodiments of method of the present invention may include storing, processing, disclosing, and protecting certain and all data and appraisal histories in accordance with state and federal privacy laws.

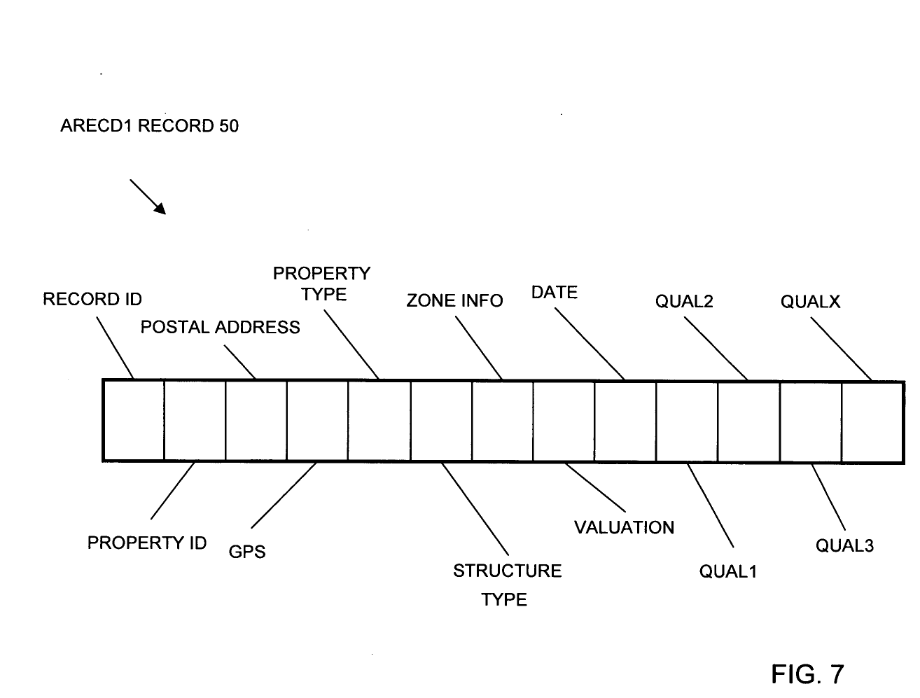

Referring now generally to the Figures and particularly to FIG. 7, FIG. 7 is a schematic of an appraisal record ARECD1 50 as stored in a database of the network of FIG. 1. The appraisal record ARECD1 50 comprises a plurality values, to include: a record identifier RECORD ID of a property (hereafter “instant property”), a property identifier PROPERTY ID of the instant property, e.g., a parcel number, a mailing address of the instant property POSTAL ADDRESS, a global positioning data GPS describing the location, metes and bounds of the instant property, a type indicator of the instant property PROPERTY TYPE, a structure type indicator STRUCTURE TYPE describing one or more structures located within the instant property, zoning information ZONE INFO applicable to the instant property, a financial valuation VALUATION made of the instant property as authored by the appraiser identified in the NAME data field of the appraiser record of FIG. 4, a date that the VALUATION value was generated by the appraiser, and a plurality of quality data fields QUAL1-QUALX that identify the existence and degree of a specified quality of the real property identified by the RECORD ID, e.g., altitude, geologic data, water rights, and/or encumbrances. In one exemplary quality value, a QUAL1 value may indicate that the appraiser referenced in a NAME value of an appraiser profile 44 is authorized to make appraisals of up to a certain property valuation level, e.g., up to one million United States dollars. In another exemplary quality value, a QUAL2 value may indicate that the appraiser referenced in a NAME value of an appraiser profile 44 is authorized to make appraisals of above a certain property valuation level, e.g., above one million United States dollars. In yet another exemplary quality value, a QUAL3 value may a quality ranking of accuracy and/or reliability of the information contained within the ARECD1 50.

The PROPERTY TYPE value might indicate whether an instant real property is used as, or zoned as, a property of one of the following types: residential, commercial, industrial, light industrial, agricultural, hazardous containment, or other suitable property category, property use category, or zoned property category in accordance with applicable laws, legally significant regulations and/or court orders.

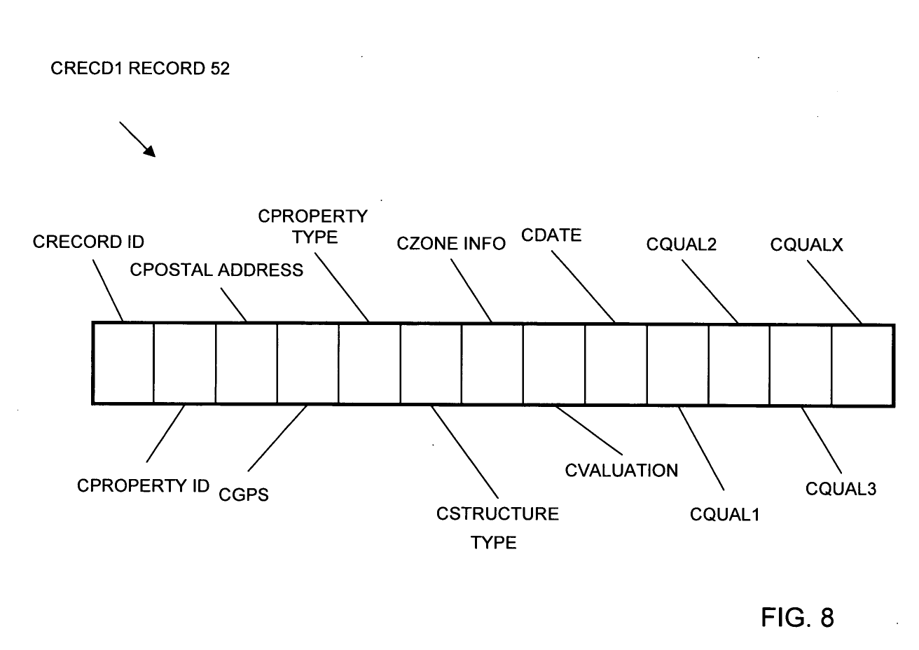

Referring now generally to the Figures and particularly to FIG. 8, FIG. 8 is a schematic of a comparable property data record CRECD1 52 as stored in a software database 42 of the network of FIG. 1. The comp record CRECD1 52 comprises a plurality values, to include: a record identifier RECORD ID of a comparable property (hereafter “instant comp property”), a comp property identifier CPROPERTY ID of the instant property, e.g., a parcel number, a mailing address of the instant comp property CPOSTAL ADDRESS, a global positioning data CGPS. describing the location, metes and bounds of the instant property, a type indicator of the instant comp property CPROPERTY TYPE, a structure type indicator CSTRUCTURE TYPE describing one or more structures located within the instant comp property, zoning information CZONE INFO applicable to the instant comp property, a most recent sales price CVALUATION value the instant comp property as referenced by the appraiser identified in the NAME data field of the appraiser record of FIG. 4, a date that the most recent sales price CVALUATION was legally recorded, made public or accessible, and a plurality of quality data fields CQUAL1-CQUALX that identify the existence and degree of a specified quality of the real property identified by the CRECORD ID, e.g., altitude, geologic data, water rights, and/or encumbrances.

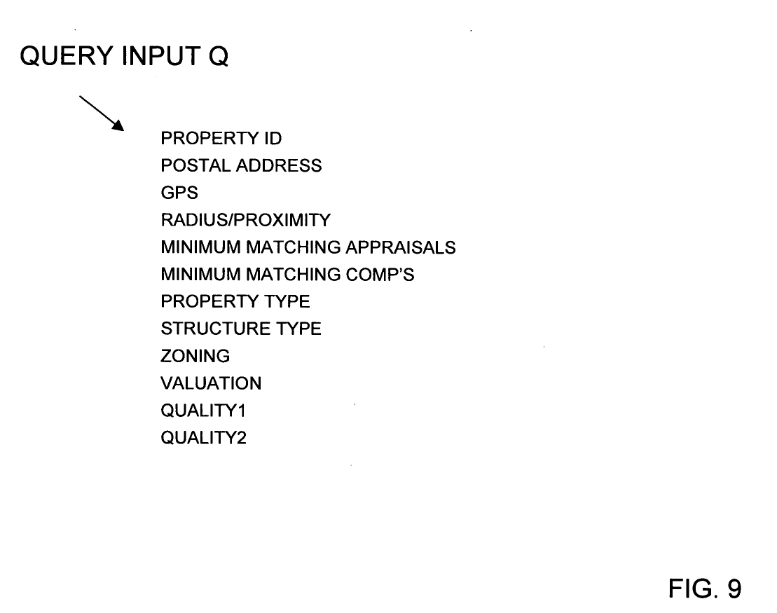

Referring now generally to the Figures and particularly to FIG. 9, FIG. 9 is an example of a query input submission to a database manager 38 and/or a query engine 40 of the network 2 of FIG. 1. The user may specify (by input to a computational system 4, 6 or 8) a property identifier, a postal address and a global positioning data of a subject property. The user may further specify a distance or a radius from the subject property that an appraised properties and/or comparable property references must be located in order to be counted as a relevant datum in evaluating an appraiser's experience in view of the subject property. The user may further specify a minimum of appraisals that must have been performed by an appraiser, and that lie within the distance or radius from the subject property as specified by the user, in order for an appraiser's profile to be selected from the data base and presented by the network and the computer to the user in response to the query. The radius may be expressed as a measure of proximity value, i.e., a minimum distance existing between a target property and (a.) a previously appraised property or (b.) a comparable property referenced by an appraiser in order for an appraisal or comparable property reference to be counted as indicating that an appraiser's name shall be provided to a user in reference to a target property submitted by the user. The proximity value may be specified as a value of less than or equal to (1.) 100 meters or yards, (2.) one eighth of a mile, (3.) one half of a kilometer, (4.) one half of a mile, (5.) one kilometer, (6.) one mile, (7.) two miles, (8.) five miles, (9.) ten miles, or (10.) 100 miles. The user may additionally or alternatively specify a minimum of comparable properties that must have been referenced in a real property appraisal performed by an appraiser, and wherein the comparable property lies within the distance or radius from the subject property as specified by the user, in order for an appraiser's profile to be selected from the data base and presented by the network and the computer to the user in response to the query. The user may optionally, alternatively or additionally identify specific qualifying characteristics of the appraised properties or comparable properties referenced by an appraiser that must be found in or associated with an appraised property or a referenced comparable property in order for the query engine and/or the database manager to count an appraisals or a comparable property reference as valid and applicable to satisfy the user specified minimum matching appraisals or referenced comparable properties requirement. The qualifying characteristics specified by the user in the query may include property type, structure type(s), zoning information, valuation magnitude or range, and/or one or more of the quality values QUAL1-QUALX.

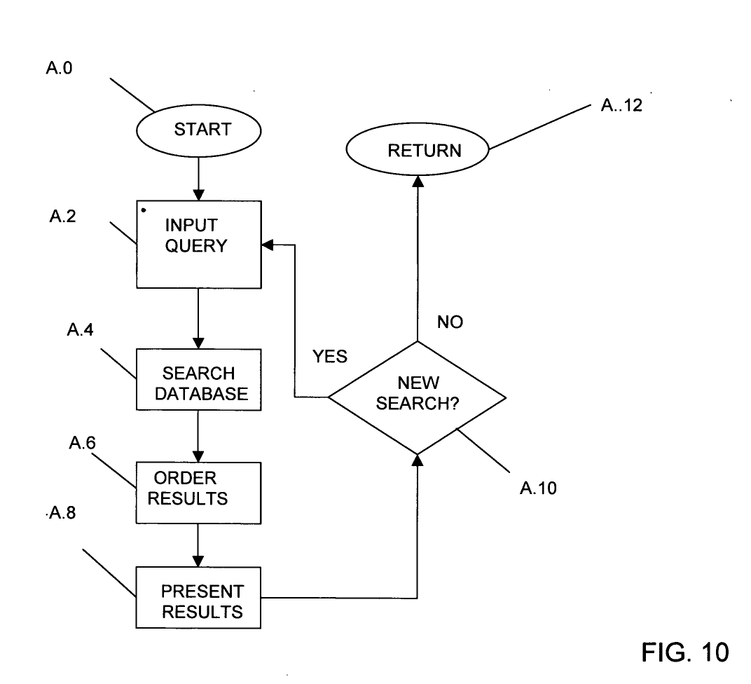

Referring now generally to the Figures and particularly to FIG. 10, FIG. 10 is a flowchart of the system software of the computer 4 or a workstation 8 of the network 2 of FIG. 1, wherein a first preferred embodiment of the method of the present invention is implemented. In step A.2 the user inputs the query of FIG. 9 into the computer or into the network via the computer. In step A.4 the computer or network searches one or more databases for records that match the query parameters and that identify an appraiser. In step A.6 the findings of step A.6 are ordered for presentation, e.g., the appraisers may be identified in an order from most to least of appraisals made within the preceding six months of the date of the query and of properties located within two miles of the subject property. In step A.8 the results ordered in step A.6 are presented via the computer or other suitable element of the network, e.g., a workstation, to the user or other party. In step A.10 the computer determines whether an additional query is to be performed, and if so, the computer proceeds from step A.10 on to execute step A.2. Alternatively, the computer may proceed from A.10 to step A.12 and to return to other operations.

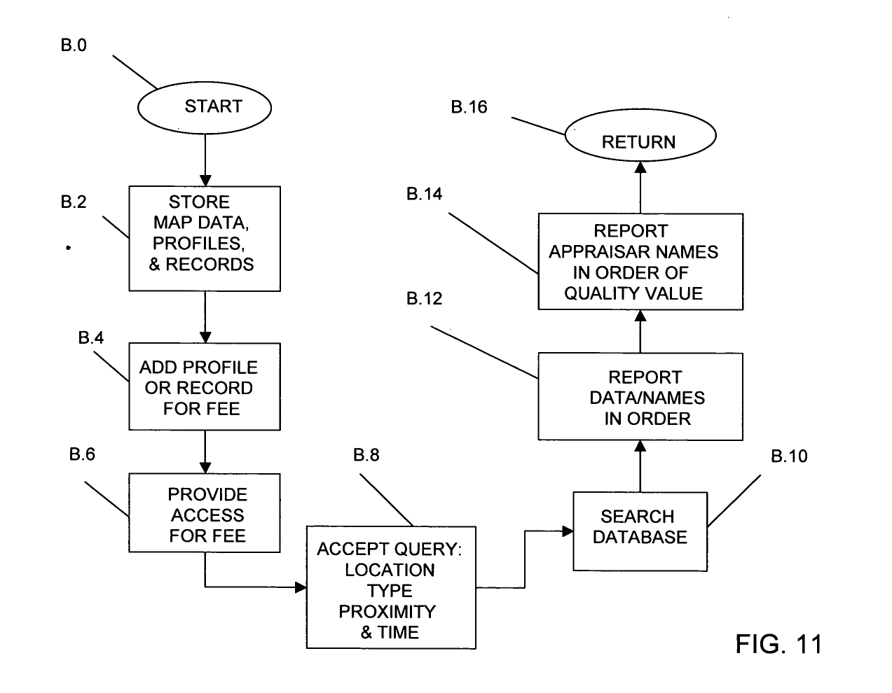

Referring now generally to the Figures and particularly to FIG. 11, FIG. 11 is a process chart of a business method comprising a first alternate preferred embodiment of the method of the present invention. In process step B.2 map and global positioning data is stored in the map/GPS data 43 and other records 44-56 are stored in the database 42, to include appraiser records 44. In process step B.4 an appraiser profile 44 or other record 46-56 may be added or updated based upon a fee or other compensation provided by a user or appraiser submitting or sourcing the new record 44-56 or new update information. In step B.8 the network 2 and/or a computational system 4, 6, or 8 provides access to the database 42 and in process step B.8 the network 2 and/or a computational system 4, 6, or 8 accepts a query from a user or appraiser. In step B.10 the query is applied by the query engine 40 and/or the database manager 38 to search the database 42. In process step B.12 the network 2 and/or a computational system 4, 6, or 8 reports data to the user in response to the query submitted in process step B.8. In step B.14 the report of data harvested from the database 42 in step B.10 may be ordered according to a criteria supplied by the user or appraiser, e.g., in order of a quality ranking of the reliability, integrity or timeliness of the data harvested.

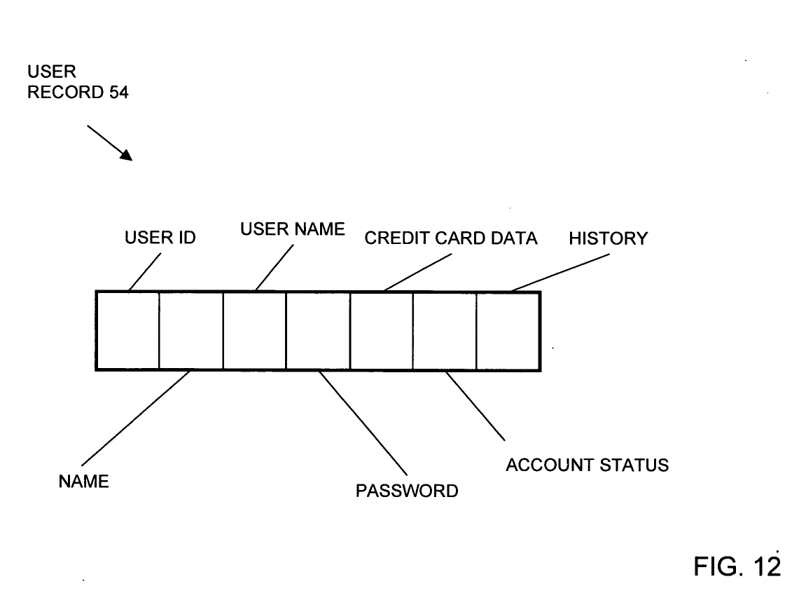

Referring now generally to the Figures and particularly to FIG. 12, FIG. 12 is a schematic diagram of a user record 54. Each user record 54 includes a USER ID value that identifies and distinguishes the instant user record 54 within the database 42; a NAME value associated with a user identified by the user record 54; a USER NAME value; a PASSWORD value; a CREDIT CARD DATA value(s) for use in billing user fees and database access subscription fees; a user ACCOUNT STATUS value for indicating whether the user referenced by the instant user record 54 is permitted to access the database 42; and a HISTORY data collection of past interaction of the user with the database software 32.

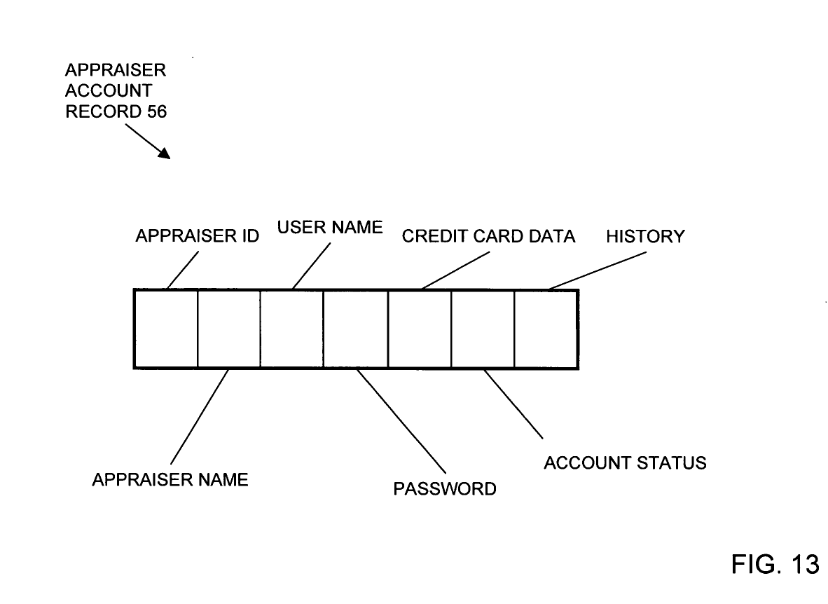

Referring now generally to the Figures and particularly to FIG. 13, FIG. 13 is a schematic diagram of an appraiser account record 56. Each appraiser account record 56 includes an APPRAISER ID value that identifies and distinguishes the instant appraiser account record 56 within the database 42; an APPRAISER NAME value associated with a user identified by the appraiser account record 56; a USER NAME value; a PASSWORD value; a CREDIT CARD DATA value(s) for use in billing user fees and database access subscription fees; a user ACCOUNT STATUS value for indicating whether the user referenced by the instant user record 54 is permitted to access, read, add and/or modify records 44-56 of the database 42; and a HISTORY data collection of past interaction of the appraiser with the database software 32.

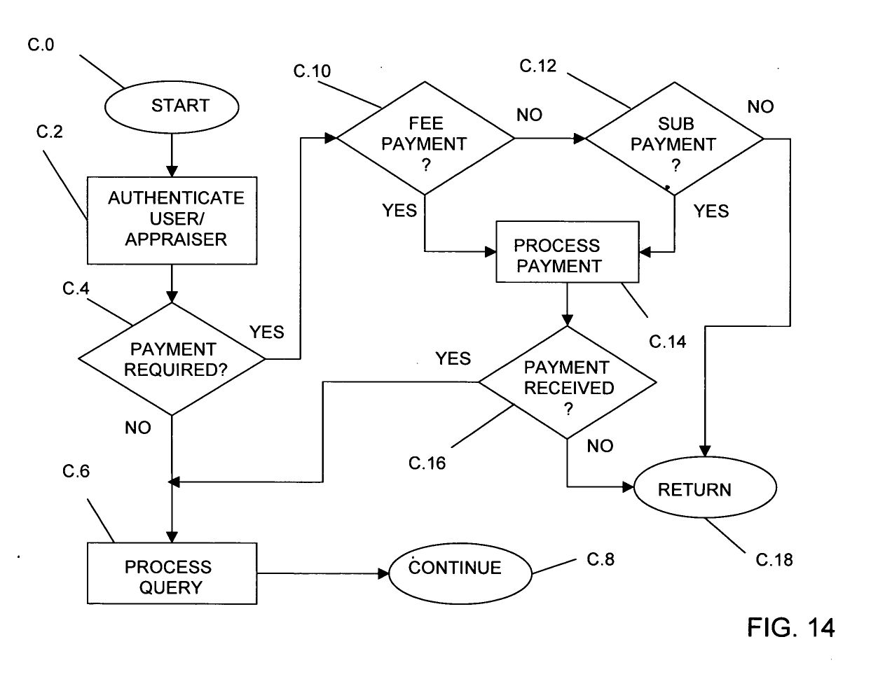

Referring now generally to the Figures and particularly to FIG. 14, FIG. 14 is a flow chart of a user or appraiser interaction with the database software 32 and in accordance with a second preferred embodiment of the method of the present invention. In step C.2 the system software 28 authenticates a user or an appraiser by use of a USER NAME VALUE and a PASSWORD value stored in a user record 54 and/or an appraiser account record 56. In step C.4 the system software 28 determines whether a payment is required to enable a user or appraiser identified in step C.2 to access the database 42. When no further payment is required, the system software 28 accepts and processes a user or appraiser query in step C.6. The system software 28 proceeds from step C. and to additional or subsequent operations. When additional payment is required, the system software determines in step C.10 if a fee-per-access is required or requested. Alternatively, the system software determines in step C.12 if a subscription payment is required or requested under which terms a user an appraiser may request multiple accesses to the database 32 within a set time period, or before a set end-of-subscription-term date. In step C.14 a subscription payment or a fee-per-access-request is processed. When the payment is successfully processed, the system software 28 proceeds from step C.14, through step CV.16 and to step C.6. Where a payment is required but not successfully processed through step C.14, the system software 28 proceeds from step C.12 or step C.16 to step C.18 and to alternate operations.

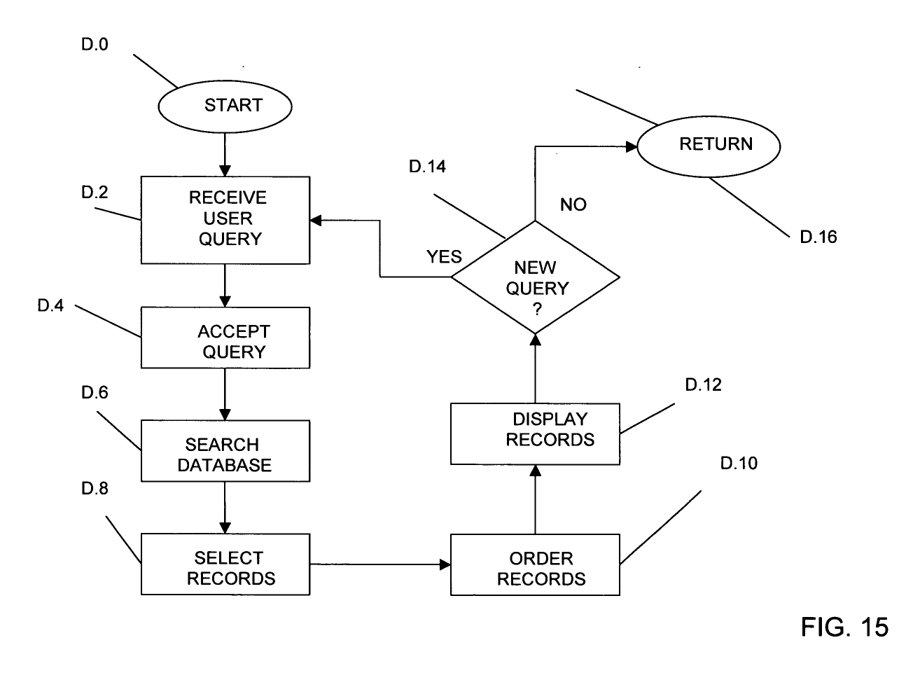

Referring now generally to the Figures and particularly to FIG. 15, FIG. 15 is a flow chart of a user or an appraiser interaction with the database software 32 and in accordance with a third preferred embodiment of the method of the present invention that may be executed within the step C.6 of FIG. 14. In step D.2 the system software 28 receives a request to access the database 32 by a user or appraiser as authorized in accordance with the process of FIG. 14, and the query engine 40 or database manager 38 generates a query Q on the basis of information provided by the requesting user. It is understood that an appraiser may also be a user or identified as a user by the system software 28. In step D.4 the database software accepts the query Q and searches the database 42 in step D.6. In step D.8 the database manager 38 selects records 44-56 from the database 42 corresponding to information requested in the query Q and orders the records 44-56 in accordance with any ordering preferences contained within the query Q and/or associated with the requesting user or appraiser, and in step D. 12 the computer 4 displays the records 44-56, or information harvested from the records 44-56. The system software 28 determines in step D.14 whether the user or appraiser has initiated one or more additional generations of a query Q.

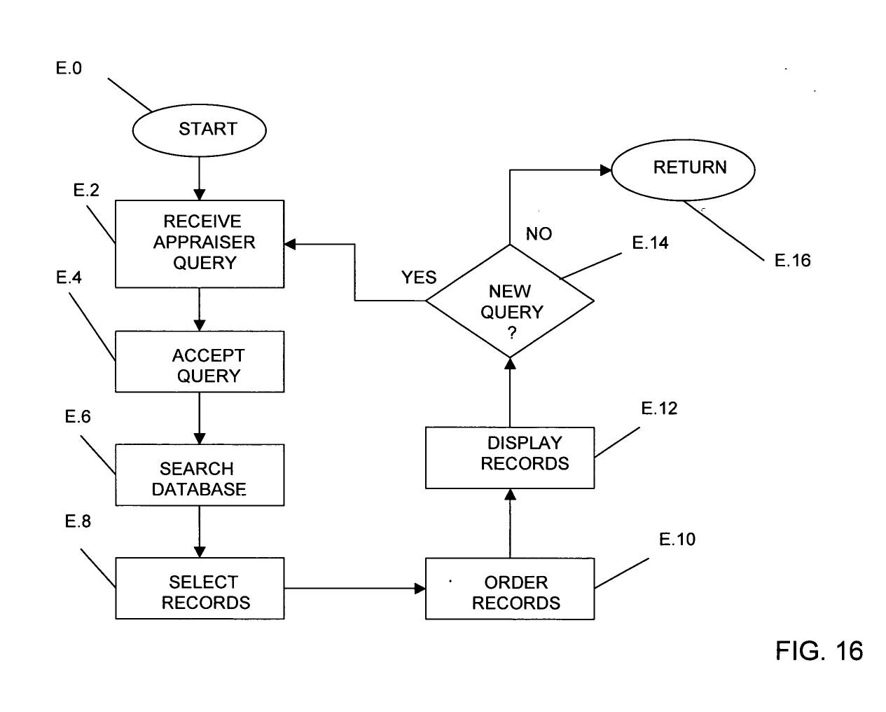

Referring now generally to the Figures and particularly to FIG. 16, FIG. 16 is a flow chart of an appraiser interaction with the database software 32 and in accordance with a fourth preferred embodiment of the method of the present invention that may be executed within the step C.6 of FIG. 14. In step E.2 the system software 28 receives a request to access the database 32 by an authorized appraiser (and in accordance with the authorization process of FIG. 14) and the query engine 40 or database manager 38 generates a query Q on the basis of information provided by the requesting appraiser. In step E.4 the database software accepts the query Q and searches the database 42 in step E.6. In step E.8 the database manager 38 selects records 44-56 from the database 42 corresponding to information requested in the query Q and orders the records 44-56 for display in accordance with any ordering preferences contained within the query Q and/or associated with the requesting appraiser, and in step E.12 the computer 4 displays the records 44-56, or information harvested from the records 44-56. The system software 28 determines in step E.14 whether the appraiser has initiated one or more additional generations of a query Q.

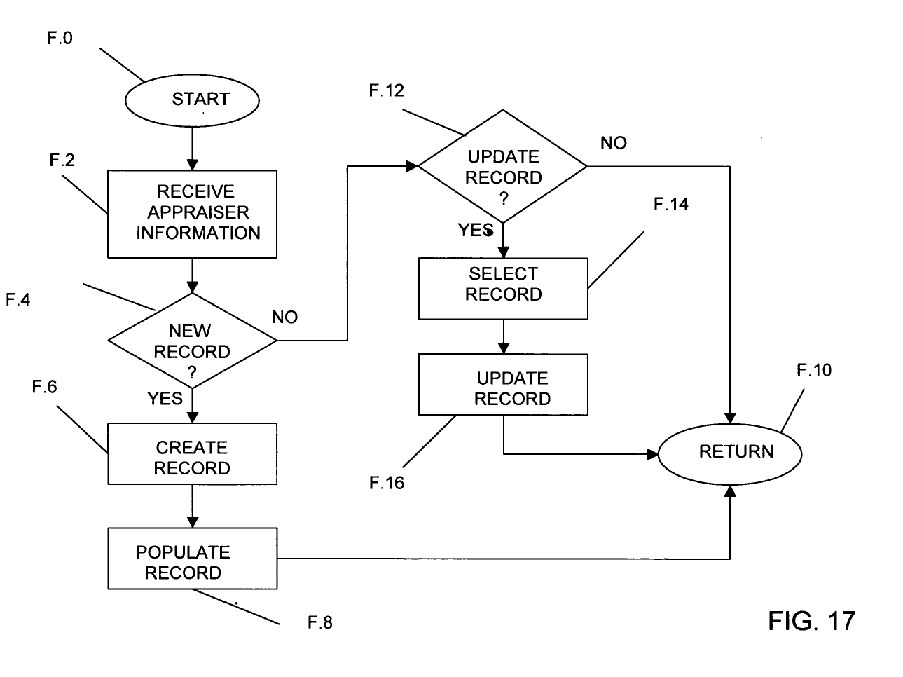

Referring now generally to the Figures and particularly to FIG. 17, FIG. 17 is a flow chart of an alternate or additional appraiser interaction with the database software 32 and in accordance with a fifth preferred embodiment of the method of the present invention that may be executed within the step C.6 of FIG. 14. In step F.2 the system software 28 receives information and a request to create a new record 44-56 or for updating of an existing record 44-56. The system software 28 determines in step F.4 whether some or all of the information received in step F.2 shall be stored in an existing record 44-56 or, alternatively, whether a new record 44-56 shall be created. In step F.6 a new record is created and in step F.8 the newly created record is populated at least partially with information received or derived from at least some of the information received in step F.2. The system software 28 proceeds from step F.8 to step F.10 and to perform alternate operations. Alternatively, when the system software 28 proceeds from step F.4 to step F.12, a record or records 44-56 are selected for updating in step F.14 (and in accordance with the information received in step F.2) and the selected record(s) are updated in step F.16. The system software 28 proceeds on from step F.16 to step F.10 and to perform alternate operations.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible embodiments of the Present Invention. The examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the Present Invention as disclosed and claimed should, therefore, be determined with reference to the knowledge of one skilled in the art and in light of the disclosures presented above.

We claim:

1. In an information technology system having a software database, a method of evaluating real estate appraisers, the method comprising:
a. Storing a plurality of histories of real property appraisals by each of a plurality of appraisers in the software database;
b. Comparing a target real property against the plurality of histories; and
c. Determining the history that lists the most real property appraisals proximate to the target real property.

2. The method of claim one, wherein the appraiser associated with the history determined in step c is communicated as a selection to a customer, the customer providing a compensation for the selection.

3. The method of claim 1, wherein at least one history includes comparative real properties used by an appraiser.

4. The method of claim 3, wherein the at least one history includes at least one comparative real property of an appraisal and does not include the appraised property.

5. The method of claim 1, wherein at least one appraiser provides compensation in return for providing a history for inclusion in the software database.

6. The method of claim 1, wherein read access to the software database is provided on a fee basis.

7. The method of claim 6, wherein read access to the software database is provided on a subscription basis.

8. The method of claim 1, wherein each history is grouped into one of a plurality of types, wherein each type corresponds to real properties having at least one specified quality.

9. The method of claim 8, wherein the types of histories are selected from the group consisting of residential, commercial, industrial, light industrial, agricultural and hazardous containment.

10. The method of claim 1, wherein at least one history includes an indication of the quality of appraisal values of an associated appraiser.

11. The method of claim 1, wherein the information technology system is communicatively coupled with an electronic communications network, the method further comprising providing the appraiser associated with the history determined in step c via the electronic communications network.

12. The method of claim 11, wherein the electronic communications network comprises the Internet.

13. The method of claim 1, wherein method further comprises selecting at least two histories on the basis of information contained within each history and specifying real property located within a proximity of to the target property.

14. The method of claim 13, wherein the method comprises providing the name of each appraiser associated with each of the at least two selected histories to a user.

15. The method of claim 14, wherein the names of each appraiser are provided in an order of histories most proximate to least proximate to the target property.

16. The method of claim 1, wherein the histories contain information related to appraisals performed no earlier than a certain time period.

17. The method of claim 1, wherein the certain time period is selected from the group consisting of one month, three months, six months, one year, two years three years and five years.

18. An information technology system, the information technology system comprising:
a. Means for storing real estate appraisal histories (hereafter “appraisals”) of a plurality of appraisers; and
b. Means for determining which appraiser is most experienced in appraising real properties proximate to a target property.

19. The system of claim 18, wherein the system further comprises means for ranking at least two appraisers for experience in appraising real properties proximate to the target property, and communicating the relative rankings to a user.

20. A computer-readable media comprise software-encoded instructions that direct the information technology system to practice the method of claim 1.
